(19) United States
(12) Patent Application Publication
(10) Pub. No.: US 2026/0367630 A1
(43) Pub. Date: Nov. 19, 2026

(54) SMOOTH CONTROL METHOD, INTELLIGENT SYSTEM, AND COMPUTER-READABLE STORAGE MEDIUM

(71) Applicant: JIANGSU DONGCHENG M&E TOOLS CO., LTD., NANTONG (CN)

(72) Inventor: WUBIN ZHEN, NANTONG (CN)

(21) Appl. No.: 19/724,897

(22) Filed: Jun. 30, 2026

Related U.S. Application Data
(63) Continuation of application No. PCT/CN2025/115687, filed on Aug. 19, 2025.

(30) Foreign Application Priority Data
Aug. 30, 2024 (CN) 202411210855.7

(51) Int. Cl. G05D 1/43; A01D 34/00; A01D 101/00; G05D 1/222; G05D 105/15

(52) U.S. Cl. CPC G05D 1/43; G05D 1/222; A01D 34/008; A01D 2101/00; G05D 2105/15

(57) ABSTRACT

A smooth control method, an intelligent system, and a computer-readable storage medium are provided. Operation information inputted by a user in a designated region is received. Position change information is determined according to the operation information. A control instruction for an intelligent device is determined according to the position change information, to control a state of the intelligent device.

### CROSS REFERENCE TO RELATED APPLICATIONS

The present application is a continuation of PCT Patent Application No. PCT/CN2025/115687, entitled “SMOOTH CONTROL METHOD, INTELLIGENT SYSTEM, AND COMPUTER-READABLE STORAGE MEDIUM,” filed Aug. 19, 2025, which claims the benefit of priorities to Chinese Patent Application No. 202411210855.7, entitled “SMOOTH CONTROL METHOD, INTELLIGENT SYSTEM, AND COMPUTER-READABLE STORAGE MEDIUM,” filed on Aug. 30, 2024, each of which is incorporated herein by reference in its entirety.

### TECHNICAL FIELD

The present disclosure relates to a smooth control method, an intelligent system, and a computer-readable storage medium.

### BACKGROUND

During processes in which a lawn mowing robot establishes boundaries such as a boundary map boundary, an island map boundary, and a restricted area boundary, as well as during a process of simply moving the lawn mowing robot, manual control of travelling of the robot is involved. In the conventional manual control method, a control instruction is directly sent to a bottom-layer execution unit without undergoing a closed-loop control process and a model-solving process of an algorithm module, resulting in unsmooth or non-uniform motion of the robot under control of a user. As a result, operation is relatively rigid. Moreover, once affected by terrain, the robot traveling in a straight line may deviate in heading direction, frequent operations are necessary to adjust the heading direction, resulting in poor user experience.

In existing remote control solutions, a mobile phone terminal is desired to be generally equipped with a gravity sensor, a gyroscope, or the like, or certain requirements are imposed on performance and computing power of the mobile phone, so as to calculate a movement instruction for the robot according to an instruction inputted by a user. However, due to differences in performance, response speeds of different mobile phone terminals to user input information are different, resulting in differences in output of the movement instructions. In particular, when the mobile phone experiences lagging or when various background programs are running, the robot may fail to accurately obtain the movement instruction, thereby causing problems such as no response, slow response, or erroneous response. Under such circumstances, the user cannot determine whether the problem is caused by the mobile phone or the robot, thereby affecting user experience.

The present disclosure aims to solve the problem of inaccurate instructions and poor operation experience of a user mobile terminal when manually operating a lawn mowing robot.

### SUMMARY

In view of deficiencies in the related technologies, a smooth control method is provided according to the present disclosure. The method includes: receiving operation information inputted by a user in a designated region, where the designated region refers to an operable region of a mobile terminal for the user; determining position change information according to the operation information; and determining, according to the position change information, a control instruction for the intelligent device, to control a state of the intelligent device.

An intelligent system is further provided according to the present disclosure. The intelligent system includes at least one memory and at least one processor. The memory is configured to store a computer program executable on the processor, which, when executed by the processor, causes the processor to perform operations of: receiving operation information inputted by a user in a designated region, where the designated region is a symmetrical figure having a center; determining position change information according to the operation information, where the position change information is determined according to a position at which the user operates relative to the center; and determining, according to the position change information, a control instruction for the intelligent device, to control a state of the intelligent device.

An intelligent system is further provided according to the present disclosure. The intelligent system includes a mobile terminal and an intelligent device. The mobile terminal is configured to control the intelligent device so that the intelligent device performs movement. The mobile terminal and the intelligent device cooperate to implement the following operations of: receiving operation information inputted by a user in a designated region, where the designated region is a symmetrical figure having a center; determining position change information according to the operation information, where the position change information is determined according to a position at which the user operates relative to the center; and determining, according to the position change information, a control instruction for the intelligent device, to control a state of the intelligent device.

### BRIEF DESCRIPTION OF THE DRAWINGS

FIG. 1 is a schematic diagram of a coordinate system of a designated region according to some embodiments of the present disclosure; and

FIG. 2 is a schematic diagram of a coordinate system with an error range according to some embodiments of the present disclosure.

### DETAILED DESCRIPTION OF THE EMBODIMENTS

The terms used herein are merely for purposes of describing specific embodiments and are not intended to limit the present disclosure.

In view of deficiencies existing in the related technologies, the present disclosure aims to provide a control solution having accurate recognition on user instruction and improved user experience.

A smooth control method is provided according to the present disclosure. The method includes: receiving operation information inputted by a user in a designated region, where the designated region is a symmetrical figure having a center, the position change information is determined according to a position at which the user operates relative to the center, and the figure may be circular, square, or the like; determining position change information according to the operation information; and determining, according to the position change information, a control instruction for an intelligent device, to control a state of the intelligent device.

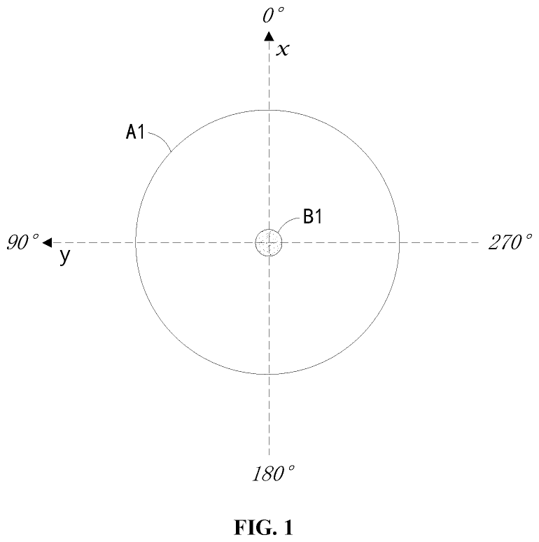

As shown in FIG. 1, the user can view the designated region, for example a disk A1, on a display interface of a mobile terminal such as a mobile phone or a PAD, and an indicator located at a center of the disk A1, e.g., a small ball B1. A control instruction is generated based on a position of the movable small ball B1 relative to the center of the disk A1 controlled by the user. That is, the user determines position change information by controlling movement of the small ball B1, thereby generating the control instruction.

In order to improve convenience of user operation, a ratio of an area of the designated region to an area of the display interface of the mobile terminal ranges from 0.15 to 0.45. In some embodiments, the ratio is a constant within the range from 0.15 to 0.45, e.g., 0.2 or 0.25. The designated region can be automatically scaled according to different display interfaces of the mobile terminal so as to ensure comfortable visual experience for the user. The display interface refers to a display screen of the mobile terminal or a region of the display screen occupied by an application operation interface. The area of the display screen occupied by the application operation interface is less than or equal to the area of the display screen of the mobile terminal.

In some embodiments, the intelligent device determines a control instruction for the intelligent device according to the position change information so as to control a state of the intelligent device. In the present disclosure, in order to reduce requirements on performance and computing power of a mobile terminal, e.g., a mobile phone, the mobile terminal, once receiving operation information inputted by a user, obtains position change information of an indicator relative to a center of a designated region, for example, position change information of the small ball B1 relative to a center of the disk A1, and then transmits the position change information to the intelligent device. The intelligent device processes the information according to a preset algorithm and generates a control instruction. In this way, requirements on computing power and performance of the mobile terminal can be significantly reduced, thereby preventing degradation of user experience caused by insufficient computing power or performance of the mobile terminal.

In some embodiments, the above process may be divided into several blocks, namely: (1) coordinate confirmation, (2) coordinate conversion, (3) parameter conversion, (4) control information calculation, and (5) generation of a control instruction. In some other embodiments, a user mobile terminal has relatively high performance, the above process of generating the control instruction may also be executed in the mobile terminal. Alternatively, operations executed in the mobile terminal and operations executed in the intelligent device may be selected by an operator as needed. In some other embodiments, when the user opens a display interface of the mobile terminal, the mobile terminal automatically calculates a computing power distribution between the mobile terminal and the intelligent device, and then automatically determines, according to the computing power distribution, whether the mobile terminal executes block (1), blocks (1) and (2), blocks (1), (2), and (3), blocks (1), (2), (3), and (4), or blocks (1), (2), (3), (4), and (5). The computing power distribution may be evaluated according to parameters such as memory, which is a common function in performance detection of mobile phones, computers, and the like, and therefore the computing power evaluation will not be detailed herein. In this way, not only can personalized requirements of users be satisfied, but also computing resources can be effectively utilized, thereby improving user experience.

In some embodiments, determining position change information according to the operation information includes: determining a position change within the designated region according to the operation information inputted by the user. The position change information may be represented by coordinates in a pre-established coordinate system. Determining, according to the position change information, the control instruction for the intelligent device includes: processing the position change information within the designated region, to determine the control instruction for the intelligent device. The processing the position change information includes converting the above coordinates into a polar coordinate system.

In some embodiments, the method further includes: obtaining sensitivity information of an operation, where the sensitivity information may refer to a mapping relationship between a movement speed/an angular velocity of the position at which the user operates and a movement speed/an angular velocity of the intelligent device. For example, the sensitivity information may indicate that a maximum speed reachable by manual control is Vₘₐₓ, and a maximum angular velocity reachable by manual control is ωₘₐₓ. The maximum speed Vₘₐₓ and the maximum angular velocity ωₘₐₓ are a maximum speed and a maximum angular velocity supported by the intelligent device, respectively.

Determining, according to the position change information, the control instruction includes: determining the control instruction according to the position change information and the sensitivity information.

In some embodiments, the above method specifically includes the following first to fifth operations.

The first operation involves (1) coordinate confirmation, in which a user performs an operation on a display interface of a mobile terminal. A right-handed coordinate system is established on the display interface by taking a center of a disk A1 as an origin and taking an upward direction as a positive direction of an x-axis, as shown in FIG. 1. When the small ball B1 moves, a position of a center of the small ball in the established coordinate system is recorded as (x, y).

The second operation involves (2) coordinate conversion, in which rectangular coordinates of the center position of the small ball are converted into polar coordinates (ρ, θ) as follows.

$$\begin{matrix}ρ = \sqrt{{x}^{2} + {y}^{2}} \\ θ = arc tan ( \frac{y}{x} )\end{matrix}$$

The third operation involves (3) parameter conversion, includes setting a maximum manual control speed to Vₘₐₓ, and a maximum angular velocity to ωₘₐₓ. The maximum speed Vₘₐₓ and the maximum angular velocity ωₘₐₓ are respectively a maximum movement speed and a maximum angular velocity supported by the intelligent device. A radius of the disk is R. In this case, a control quantity for the motion center of the lawn mowing robot corresponding to the small ball B1 is calculated as follows.

$$\begin{matrix}v = \frac{ρ}{R} \cdot {v}_{max} \cdot cos ( θ ) \\ ω = \frac{ρ}{R} \cdot {ω}_{max} \cdot sin ( θ )\end{matrix}$$

In some other embodiments, the control quantity is calculated as follows.

V=k·Vₘₐₓ·cos(θ)

ω=k·ωₘₐₓ·sin(θ)

Here, k has a value ranging from 0 to 1. Preferably, k is selected from at least one of 0.25, 0.3, 0.35, 0.4, 0.45, 0.5, 0.55, 0.6, 0.65, 0.7, 0.75, 0.8, 0.85, 0.9, and 1. Preferably, the number of k may be one, two, three, four, or more, and corresponding speed gears are displayed on a user operation interface. That is, in a case that two values of k are selected, two gears are displayed on the operation interface. In a case that three values of k are selected, three speed gears are displayed on the operation interface; and so on. During actual operation, the user can select one of the speed gears through the operation interface, such as a speed gear on an APP interface, to satisfy different control requirements of the user and improve user experience.

Specifically, before a user starts remotely controlling the lawn mowing robot to move, that is, before receiving operation information inputted by the user in the designated region, the method further includes: the user selecting a speed gear through an operation interface so as to determine a maximum operating speed of the lawn mowing robot according to the speed gear, and then performing a remote control operation.

The fourth operation involves (4) control information calculation. Assuming that diameters of left and right wheels are equal to D, a distance between the left and right wheels is W_{D}, and speed ratios of left and right traveling motors are equal to Gᵣₐₜᵢₒ. The control quantity of motion center is converted into rotational speeds of left and right traveling motors of the lawn mowing robot through a model-solving module as follows.

$$\begin{matrix}{n}_{L} = \frac{( 2 \cdot v - ω \cdot {W}_{D} ) \cdot {G}_{ratio}}{2 \cdot π \cdot D} \\ {n}_{R} = \frac{( 2 \cdot v + ω \cdot {W}_{D} ) \cdot {G}_{ratio}}{2 \cdot π \cdot D}\end{matrix}$$

The fifth block involves (5) generation of a control instruction, includes: generating the control instruction according to rotational speeds n_{L} and n_{R} of the left and right traveling motors, to control movement of left and right wheels of the lawn mowing robot.

According to the present disclosure, operation information inputted by a user in a designated region is received, position change information is determined according to the operation information, and a control instruction for an intelligent device is determined according to the position change information, so as to control a state of the intelligent device, thereby improving accuracy in recognizing user instruction.

In some embodiments, in order to improve user experience and reduce operation errors, determining, according to the position change information, the control instruction for the intelligent device includes: performing smoothing processing on the position change information so as to reduce errors in the operation information. The smoothing processing includes: obtaining an allowable operation error angle; and determining, according to the operation information inputted by the user and the operation error angle, whether the operation information falls within a range of the operation error angle, so as to determine control parameters of the intelligent device. Preferably, the allowable operation error angle is less than or equal to 10°. In some embodiments, the error angle is ±5°.

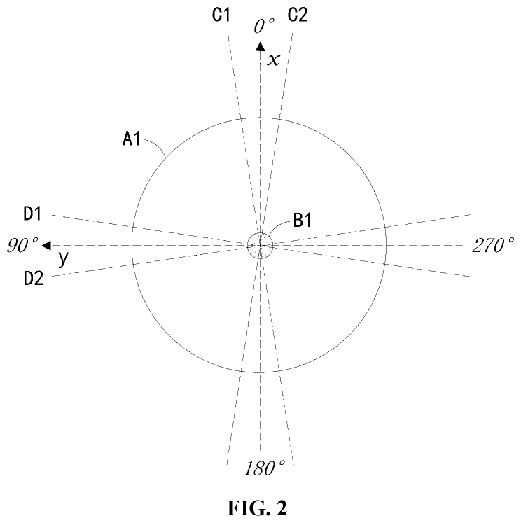

In some embodiments, in the above smooth control solution, in consideration of inaccuracy in manual operation by a user, special processing logic is provided near coordinate axes, that is, smoothing processing is performed so as to reduce operation errors. As shown in FIG. 2, a region enclosed by dashed lines C1 and C2 involves straight traveling, and a region enclosed by dashed lines D1 and D2 involves self-rotation. A specific process is as follows.

A first operation includes setting an allowable operation error angle θₑ. An allowable operation error range near each coordinate axis may be represented as follows.

$$[ normalization ( 90 {°}^{*} n - \frac{{θ}_{e}}{2} ) , normalization ( 90 {°}^{*} n + \frac{{θ}_{e}}{2} ) ]$$

Here, n=0, 1, 2, or 3, normalization represents a normalization function. In some embodiments, the error angle θₑ may be ±5°, ±6°, ±7°, ±8°, ±9°, ±10°, or the like.

A second operation includes: determining, based on (ρ, θ) obtained through the coordinate conversion in block (2), whether θ falls within the allowable operation error range described in the first operation, and obtaining a corresponding n value if determined that θ falls within the allowable operation error range.

A third operation includes: executing a forward straight traveling direction holding function if n=0. Assuming that an initial heading angle upon entering the allowable operation error range is φₑₓₚ, and a real-time heading angle during operation is σ, a control quantity of motion center of the lawn mowing robot in this case may be represented as follows.

V=Vₘₐₓ

ω=k₁·(φₑₓₚ−φ)

Here K₁ is a gain coefficient and has a value ranging from 0 to 2.

A fourth operation includes: executing a left self-rotation function if n=1. In this case, the control quantity of motion center of the lawn mowing robot is represented follows.

ν=0

ω=ωₘₐₓ

A fifth operation includes: executing a backward straight traveling direction holding function if n=2. Assuming that an initial heading angle upon entering the allowable operation error range is φₑₓₚ, and a real-time heading angle during operation is φ, the control quantity of motion center of the lawn mowing robot in this case may be represented as follows.

V=−Vₘₐₓ

ω=k₂·(φₑₓₚ−φ)

Here, K₂ is a gain coefficient and has a value ranging from 0 to 2.

A sixth operation includes: executing a right self-rotation function if n=3. In this case, the control quantity of motion center of the lawn mowing robot is represented follows.

ν=0

ω=−ωₘₐₓ

A seventh operation includes: executing (4) control information calculation to calculate rotational speeds of the left and right motors.

In the present disclosure, a smoothing processing algorithm is introduced during processing of the position change information to effectively solve the problem of inaccuracy in manual operation by a user, thereby effectively reducing operation errors.

The present disclosure further provides an intelligent system including a mobile terminal and an intelligent device. The mobile terminal may be various user devices, such as a mobile phone or a computer, and the intelligent device may be a device having a self-traveling function and an additional remote-control function, such as an intelligent lawn mower or a sweeping robot.

The mobile terminal is provided with a display interface configured to receive operation information inputted by a user in a designated region. The designated region is a symmetrical figure having a center. Position change information is determined according to a position at which the user operates relative to the center, the figure may be circular, square, or the like.

Then, position change information is determined according to the operation information. A control instruction for the intelligent device is determined according to the position change information. The intelligent device controls its state according to the control instruction.

As shown in FIG. 1, a user can view a designated region, for example a disk A1, and an indicator, for example a small ball B1, located at a center of the disk, on a display interface of a mobile terminal such as a mobile phone, computer, or PAD. A control instruction is generated based on a position of the movable small ball B1 relative to the center of the disk A1 controlled by the user. That is, the user determines position change information by controlling movement of the small ball B1, thereby generating the control instruction.

In some embodiments, the intelligent device determines a control instruction for the intelligent device according to the position change information so as to control a state of the intelligent device. In the present disclosure, in order to reduce requirements on performance and computing power of a mobile terminal, e.g., a mobile phone, the mobile terminal, once receiving operation information inputted by a user, obtains position change information of an indicator relative to a center of a designated region, for example, position change information of a small ball B1 relative to a center of a disk A1, and then transmits the position change information to the intelligent device. The intelligent device processes the information according to a preset algorithm and generates a control instruction. In this way, requirements on computing power and performance of the mobile terminal can be significantly reduced, thereby preventing degradation of user experience caused by insufficient computing power or performance of the mobile terminal.

The present disclosure further provides an intelligent system including a memory and a processor. The memory stores a computer program executable on the processor, and the processor implements the method when executing the computer program.

The present disclosure further provides a computer-readable medium having non-volatile program code executable by a processor, where the program code causes the processor to execute the method.

Those skilled in the art can clearly understand that, for convenience and brevity of description, specific operation processes of the above-described system and device may refer to corresponding processes in the foregoing method embodiments, and details thereof are not described herein again.

If the functions are implemented in the form of software functional units and sold or used as an independent product, the functions may be stored in a computer-readable storage medium. Based on such understanding, the technical solutions of the present disclosure, or in other words, portions contributing to the related technologies, or part of the technical solutions, may be embodied in the form of a software product. The computer software product is stored in a storage medium and includes a plurality of instructions for causing a computer device (which may be a personal computer, a server, a network device, or the like) to execute all or part of the operations of the method described in various embodiments of the present disclosure. The foregoing storage medium includes various media capable of storing program codes, such as a USB flash drive, a removable hard disk, a read-only memory (ROM), a random-access memory (RAM), a magnetic disk, or an optical disc.

Finally, it should be noted that the above embodiments are merely specific implementations of the present disclosure and are intended to illustrate the technical solutions of the present disclosure rather than limit the same. The protection scope of the present disclosure is not limited thereto. Although the present disclosure has been described in detail with reference to the foregoing embodiments, those skilled in the art should understand that, within the technical scope disclosed by the present disclosure, any person skilled in the art can still make modifications to the technical solutions described in the foregoing embodiments, readily conceive changes thereto, or make equivalent substitutions to some of the technical features thereof. Such modifications, changes, or substitutions do not depart from the spirit and scope of the technical solutions of the embodiments of the present disclosure, and shall all fall within the protection scope of the present disclosure. Accordingly, the protection scope of the present disclosure shall be subject to the protection scope of the claims.

What is claimed is:

1. A smooth control method, applicable to a control system comprising a mobile terminal and an intelligent device, wherein the smooth control method comprises:
receiving, by the mobile terminal, operation information inputted by a user in a designated region, wherein the designated region refers to an operable region of the mobile terminal for the user;
determining position change information according to the operation information; and
determining, according to the position change information, a control instruction for the intelligent device, to control a state of the intelligent device.

2. The smooth control method according to claim 1, wherein
determining position change information according to the operation information comprises:
determining a position change within the designated region according to the operation information inputted by the user, wherein the designated region is a symmetrical figure having a center, and the position change within the designated region refers to a change in a position at which the user operates relative to the center; and
determining, according to the position change information, the control instruction for the intelligent device comprises: processing the position change information within the designated region to determine the control instruction for the intelligent device.

3. The smooth control method according to claim 1, further comprising:
acquiring sensitivity information of an operation, wherein the sensitivity information refers to a mapping relationship between a movement speed of a position at which the user operates and a movement speed of the intelligent device, or refers to a mapping relationship between an angular velocity of a position at which the user operates and an angular velocity of the intelligent device; and
wherein determining, according to the position change information, the control instruction for the intelligent device comprises: determining the control instruction according to the position change information and the sensitivity information.

4. The smooth control method according to claim 1, wherein determining, according to the position change information, the control instruction for the intelligent device comprises:
performing smoothing processing on the position change information to reduce an error in the operation information.

5. The smooth control method according to claim 4, wherein the smoothing processing comprises:
acquiring an allowable operation error angle; and
determining, according to the operation information inputted by the user and the allowable operation error angle, whether the operation information is within a range of the allowable operation error angle, to determine a control parameter for the intelligent device.

6. The smooth control method according to claim 4, wherein the allowable operation error angle is less than or equal to 10°.

7. The smooth control method according to claim 1, wherein a ratio of an area of the designated region to an area of a display interface of the mobile terminal ranges from 0.15 to 0.45.

8. The smooth control method according to claim 1, wherein before receiving, by the mobile terminal, the operation information inputted by the user in the designated region, the method further comprises:
receiving, by the mobile terminal, gear selection information inputted by the user, to determine a maximum movement speed of the intelligent device according to the gear selection information.

9. The smooth control method according to claim 2, wherein the position change information is represented by coordinates in a pre-established coordinate system.

10. An intelligent system, comprising:
at least one memory; and
at least one processor;
wherein the at least one memory is configured to store a computer program executable by the at least one processor, which, when executed by the at least one processor, causes the at least one processor to perform operations of a smooth control method applicable to a control system comprising a mobile terminal and an intelligent device;
wherein the smooth control method comprises:
receiving, by the mobile terminal, operation information inputted by a user in a designated region, wherein the designated region refers to an operable region of the mobile terminal for the user;
determining position change information according to the operation information; and
determining, according to the position change information, a control instruction for the intelligent device, to control a state of the intelligent device.

11. The intelligent system according to claim 10, wherein a ratio of an area of the designated region to an area of a display interface of the mobile terminal ranges from 0.15 to 0.45.

12. An intelligent system, comprising:
a mobile terminal; and
an intelligent device;
wherein the mobile terminal is configured to control the intelligent device to move, and the mobile terminal and the intelligent device are configured to cooperate to implement the operations of:
receiving operation information inputted by a user in a designated region, wherein the designated region refers to an operable region of the mobile terminal for the user, and the designated region is a symmetrical figure having a center;
determining position change information according to the operation information, wherein the position change information is determined according to a position at which the user operates relative to the center; and
determining, according to the position change information, a control instruction for the intelligent device, to control a state of the intelligent device.

13. The intelligent system according to claim 12, wherein the mobile terminal is configured to receive the operation information inputted by the user in the designated region, to determine the position change information according to the operation information, and to determine the control instruction for the intelligent device according to the position change information.

14. The intelligent system according to claim 12, wherein the mobile terminal is configured to receive the operation information inputted by the user in the designated region and to determine the position change information according to the operation information, and the intelligent device is configured to determine the control instruction for the intelligent device according to the position change information.

15. The intelligent system according to claim 12, wherein the mobile terminal is configured to receive the operation information inputted by the user in the designated region, and the intelligent device is configured to determine the position change information according to the operation information and to determine the control instruction for the intelligent device according to the position change information.

16. The intelligent system according to claim 12, wherein the mobile terminal is configured to receive gear selection information inputted by the user, to determine a maximum movement speed of the intelligent device according to the gear selection information.

17. The intelligent system according to claim 12, wherein determining, according to the position change information, the control instruction for the intelligent device comprises:
performing smoothing processing on the position change information to reduce an error in the operation information;
wherein the smoothing processing comprises:
acquiring an allowable operation error angle; and
determining, according to the operation information inputted by the user and the operation error angle, whether the operation information is within a range of the operation error angle, to determine a control parameter for the intelligent device.

18. The intelligent system according to claim 12, wherein a ratio of an area of the designated region to an area of a display interface of the mobile terminal ranges from 0.15 to 0.45.

19. The intelligent system according to claim 18, wherein the area of the display interface of the mobile terminal is less than or equal to an area of a display screen of the mobile terminal.

20. The intelligent system according to claim 12, wherein the position change information is represented by coordinates in a pre-established coordinate system.
